(19) United States
(12) Patent Application Publication
(10) Pub. No.: US 2004/0201775 A1
(43) Pub. Date: Oct. 14, 2004

(54) Camera function

(76) Inventors: Wilfred Brake, Fort Collins, CO (US); Robert Paul Cazier, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/040,585

(22) Filed: Jan. 4, 2002

(51) Int. Cl. H04N 5/225

(52) U.S. Cl. 348/375

(57) ABSTRACT

A camera which includes an alarm clock is disclosed.

### BACKGROUND

Traditional cameras which capture images of objects on photographic film have been commercially available for decades. Higher quality film cameras have controls that allow a user to adjust various camera parameters such as aperture size and shutter speed. In recent years many of the parameter adjustments have been automated and/or made more convenient through use of microprocessor based controllers. Such controllers commonly include a digital display screen, which usually displays a selected parameter to be adjusted, and control interfaces such as buttons or dials which are manipulated to adjust the selected parameter. Such automated controllers have allowed manufactures to implement camera functions which were not available on cameras with only manual controls. For example, many film cameras are now provided with a time and date stamping function which causes the film to be exposed to an interval time and date display device at the time the shutter is actuated such that the time and/or the date are ‘stamped’ on the film concurrently with its exposure to light from an object. Another such function which has been available for several years is a ‘count down timer’ which causes the actuation of the camera shutter to be delayed for a preset time, e.g. 15 seconds, after the shutter button has been pushed. Cameras that are in a count down timer mode are usually accompanied by an audible signal that indicates that this ‘count down’ is in progress.

During the past several years, ‘digital cameras’ have been introduced. These cameras produce, store, and/or transmit digital data corresponding to the image of an object. Such digital cameras, like the more recent film cameras, usually employ microprocessor based control systems.

It is to be understood that the term ‘camera’ as used herein, unless otherwise prequalified, refers to digital as well as traditional film cameras and to motion picture (including film and video) as well as still picture cameras.

Cameras are described in the following patents which are hereby incorporated by reference for all that is disclosed therein: U.S. Pat. No. 4,131,919 of Lloyd et al. issued on Dec. 26, 1978 under the title ELECTRONIC STILL CAMERA, U.S. Pat. No. 4,420,773 of Toyoda et al. issued on Dec. 13, 1983 under the title ELECTRONIC PHOTOGRAPHIC CAMERA, U.S. Pat. No. 4,541,010 of Alston issued on Sep. 10, 1985 under the title ELECTRONIC IMAGING CAMERA, U.S. Pat. No. 5,918,083 of Aoki et al. issued on Jun. 29, 1999 under the title CAMERA FOR USE WITH A ROLL PHOTO FILM, U.S. Pat. No. 6,097,879 of Komatsu et al. issued on Aug. 1, 2000 under the title VIDEO CAMERA APPARATUS OF DIGITAL RECORDING TYPE and U.S. Pat. No. 5,343,243 of Maeda issued on Aug. 30, 1994 under the title DIGITAL VIDEO CAMERA.

### SUMMARY

In one embodiment, the invention may comprise a camera comprising: a camera body; and an alarm clock operably associated with the camera body.

In another embodiment, the invention may comprise a method of providing notification of the occurrence of a time of day comprising: inputting data representative of a selected time of day into a camera; and upon occurrence of the selected time of day, actuating a camera subsystem.

In another embodiment, the invention may comprise a camera comprising: means for capturing an image of an object; means for selecting a time of day; and means for actuating at least one camera subsystem at the occurrence of the selected time of day.

### BRIEF DESCRIPTION OF THE DRAWINGS

FIG. 1 shows a rear view of an exemplary embodiment of a camera.

FIG. 2 shows a top elevation view with a broken-away portion of the camera of FIG. 1.

FIG. 3 shows a schematic diagram of electronic components of an exemplary embodiment of a camera.

### DETAILED DESCRIPTION

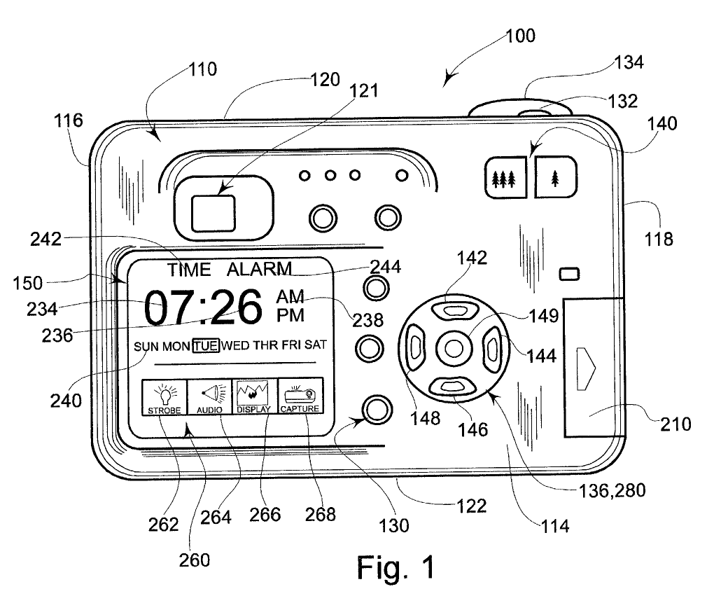

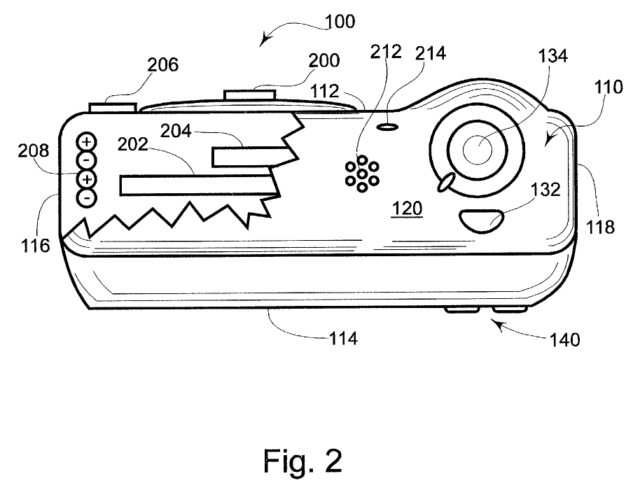

FIG. 1 shows a camera 100 having a housing 110. The housing 110 may have a front 112 (FIG. 2), a back 114, a left side 116, a right side 118, a top 120 and a bottom 122. The camera 100 may further include a plurality of user interfaces such as a mode button 130, a power button 132, a capture button 134, a menu selector 136 and a zoom toggle device 140. A variety of interfaces may be provided for operating the camera 100 as detailed later herein. The menu selector 136 may employ various types of controls including, but not limited to, two or three way discrete position switches, pressure sensitive switches, dials or other rotary devices, slide switches, or any other devices now known or later developed that allow a user to control the camera 100. One exemplary menu selector 136 is a plurality of buttons such as a first button 142, a second button 144, a third button 146, a fourth button 148 and a fifth button 149. The buttons 142, 144, 146, 148 and 149 may have electrical connections provided therewith capable of sensing activation of the buttons. Actuation of any one of the buttons may result in closing or opening of individual switches (not shown) associated therewith, thereby invoking various functions as described later herein.

The camera 100 may further include a display 150. Although a camera 100 having a display 150 mounted on the housing back 114 will be described, it is to be noted that the display 150 may be located at any position on the camera 100 such as the housing front 112, the left 116, the right 118, the top 120 or the bottom 122. The display 150 may be any of a variety of shapes, however commonly the shape is generally rectangular. The display 150 may be any of a variety of displays, such as a liquid crystal display (LCD), cathode ray tube display (CRT), light emitting diode display (LED), ferro-electric display, plasma display, etc. Imaged data of an object may be displayed on the display 150, often to preview the image formed by the image data prior to capturing the image data. Additionally, the display 150 may act as part of a user interface for any of a variety of functions provided with the camera (e.g. image previewing, mode setting, parameter adjustment, image viewing, etc.). One such function may be control of an alarm clock provided with the camera 100 as detailed later herein. The camera may include an optical viewfinder 121 instead of or in addition to the large display 150. The optical viewfinder 121 may include a smaller digital display that is shielded from glare and provides the same display functions as display 150.

With reference to FIG. 2, the camera 100 may include a lens assembly 200, a controller 202 and a photosensor array 204. The camera 100 may also include other components such as a strobe 206, a power supply 208, a storage media interface 210 (FIG. 1), a speaker 212 and a microphone 214. The lens assembly 200 may be mounted to the camera housing front 112 and in optical communication with the photosensor array 204. Light passing through the lens assembly 200 forms an image of an object on the photosensor array 204. The photosensor array 204 generates image data representative of the image of the object formed thereon in a manner well known in the art. The photosensor array 204 and other components such as the strobe 206, the power supply 208 and the storage media interface 210 are placed in electronic communication with the controller 202 such as by conventional electronic interfaces.

The camera 100 includes an alarm clock which, in one embodiment, shares functional components with other camera systems. The ‘alarm clock’ feature is herein defined as any one of a variety of actions taken to notify a user upon occurrence of a selected time of day or alternatively takes action upon occurrence of a selected time of day. A ‘selected time of day’ is herein defied as a particular point in time during the day which is selected through manipulation of the camera controller 202 without regard to the time that the selection is made. Thus a ‘count-down’ timer which operates through selection of a length of time measured from the time of selection does not allow a user to specify a ‘selected time of day’ and does not operate as an ‘alarm clock’ as defined herein (i.e. an example of a selected time of day is ‘12:32 PM’ rather than ‘five minutes from now’). Time of day is commonly defined in 12-hour periods; clocks may be provided with a 24-hour format wherein two 12-hour periods comprise an entire 24-hour day. The first twelve-hour period is commonly referred to as an AM period, while the second twelve-hour period is commonly referred to as a PM period.

In one non-limiting exemplary embodiment, the alarm clock function may notify of occurrence of a selected time of day by playing an audio file through the speaker 212 upon occurrence of the selected time of day (e.g. 7:26 PM on Tuesday as shown in FIG. 1). The alarm clock may be software or firmware integrally provided with the controller 202. As an alternative, the alarm clock may be a separate and distinct element integrated into, and functioning with, the camera 100. In one particular exemplary embodiment, the alarm clock may be firmware provided with the controller 202.

The alarm clock may include alarm interface display indicia 230 and interface controls 280 that will be further described below.

With reference to FIG. 1, the alarm clock may have one or more user selectable operating modes including, but not limited to: a strobe mode, an audio mode, an image display mode and a capture mode. Other operating modes may be provided such as a vibrate mode or other modes, which would be obvious to those skilled in the art upon reading the present disclosure, which are capable of notifying a user upon occurrence of a selected time of day.

The strobe mode may cause activation of the strobe unit 206 for providing visual notification of occurrence of the selected time of day. This visual notification in the strobe mode may be repetitive bursts of light emitted by the strobe 206 (FIG. 2) or alternatively one intense burst or ‘flash’ of light.

The audio mode may cause activation of the speaker 212 for providing auditory notification of occurrence of a selected time of day. Sound emitted by the speaker 212 may be a waveform, or alternatively a recorded data file (.e.g. a bugle playing revelry or a rooster crowing).

The image display mode may provide visual notification of occurrence of a selected time of day by displaying image data on the display 150. The image data shown on the display 150 may be data recorded by the camera 100 onto imbedded memory or removable memory.

It is noted that the audio and/or image files that may be utilized for notification of occurrence of selected time of days may be imbedded in software of firmware, or alternatively may be stored in memory. Audio and image files may be stored in permanent memory contained on the controller 202, or alternatively stored on storage media contained within the stored media interface 210. The audio and image files may be recorded by the user in a manner described later herein or alternatively provided with the camera 100 (e.g. a picture of a sunrise, a picture of a bugle, a picture of a rooster, etc.)

With further reference to FIG. 1, alarm interface display indicia 230 shown on the display 150 may include a clock display 232, a day display 240 and a plurality of alarm mode images 260. The clock display 232 may be provided with an hour display 234, a minute display 236 and an AM/PM display 238 for indicating a time of day. The time shown on the clock display 232 portion of the display 150 may be either real time or a selected time of day. Indication of time shown on the clock display 230 may be portrayed by a time indicator 242 or an alarm indicator 244. Illumination of the time indicator 242 may notify a user that the real time is being shown on the clock display 230. Alternatively, illumination of the alarm indicator 244 may notify a user that the alarm time is being shown on the clock display 230. In other words, if a selected time of day is displayed, the alarm indicator 244 is shown; if the real time is displayed, the time indicator 242 is shown. It is noted that a plurality of alarm indicators (e.g. 244) may be provided in the event that the alarm clock is provided having more than one selected time of day. The alarm interface display indicia 230 may be further provided with the day display 240 for indicating a day of the week. Additionally, the alarm interface display indicia 230 may be provided with the plurality of alarm mode images 260. In a non-limiting embodiment, the alarm mode images 260 may include a strobe image 262, an audio image 264, a display image 266 and a capture image 268 for indicating the alarm clock mode to which the alarm clock function is set.

With further reference to FIG. 1, the interface controls 280 may be any of a variety of interface controls such as the menu selector 136 having the first button 142, the second button 144, the third button 146, the fourth button 148 and the fifth button 149. The buttons (e.g., 142, 144, 146, 148, 149) may be utilized for manipulating settings for the alarm clock. Manipulation of alarm clock settings may be viewed by the user on the display 150. Such alarm clock settings may include any one of a variety of settings such as alarm mode selection as shown by the alarm mode images 260. The description of such alarm clock setting will be reserved for description later herein.

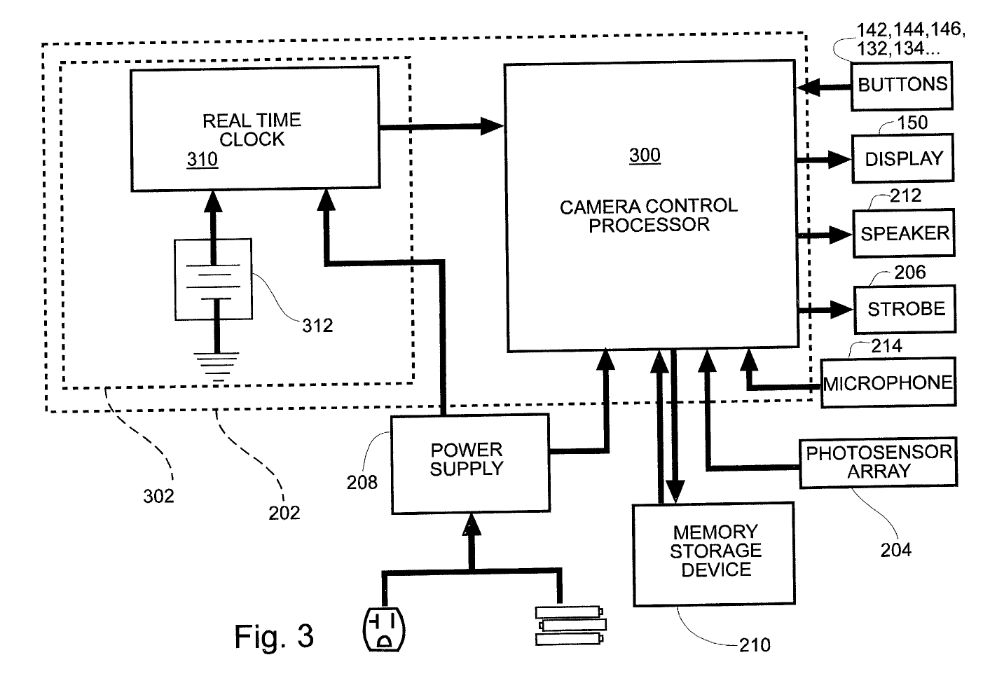

With reference to FIG. 3, a schematic illustration of the elements of a camera such as camera 100 is shown. In this exemplary embodiment, the camera 100 has various elements (e.g., 142, 144, 146, 132, 134, 150, 212, 206, 214, 210, 208, etc.) provided therewith; these elements may be altered depending on the designer's requirements. For example some of the elements may be eliminated to achieve cost savings or to make the camera more compact or simple to operate. The schematic illustration shows the controller 202 having a first portion 300 and a second portion 302. The first portion 300 includes a camera control processor 300 and the second portion includes an always-on portion 302. The always-on portion 302 may be provided with a real time clock 310 and an always-on power supply 312. The real time clock 310 may constantly track the passage of time, thereby tracking the real time of day and, in one embodiment, the day of week and date. The always-on power supply 312 may be any one of a variety of power supplies capable of powering a circuit for an extended period of time (e.g., a rechargeable battery or a super capacitor). The always-on portion 302 may draw power from the power supply 208 for operating the real time clock 310. In the event that the power supply 208 is completely drained (i.e. not capable of providing energy), the always-on power supply 312 may further power the real time clock 310. The always-on portion 302 may be operatively associated with the camera control processor 300. This operative association between the always-on portion 302 and the camera control processor 300 may result in the always-on portion 302 ‘waking’ the camera control processor 300. Furthermore, the schematic illustration shows that the camera control processor 300 may be powered by the power supply 208. The camera control processor 300 may receive input data from the buttons (142, etc.), the microphone 214, the photosensor array 204, the memory storage device 210, etc. The camera control processor 300 may output data to the display 150, the speaker 212, the strobe 206, the memory storage device 210, etc.

Having provided a description of various exemplary embodiments of cameras, a description of the utilization of the alarm clock will now be provided.

A description of the programming and activation of the camera 100 having the alarm clock will now be provided for an exemplary scenario wherein a selected time of day is to occur at 7:26 PM. Furthermore, the action of the alarm clock notifying a user of occurrence of the selected time of day will also be described.

In order to set the alarm clock, it is required to enter a selected time of day into the alarm clock. The selected time of day may be entered in a number of ways. One exemplary way of entering the selected time of day may be through the interface controls 280. Provided that the alarm hour display 234 needs to be changed to properly read seven o'clock (and assuming that the interface controls 280 have been utilized to invoke an alarm setting mode), the first button 142 or the third button 146 may be depressed until the hour display 234 shows “7”. To advance to the minute display 236, the user may depress the second button 144 to activate the minute display 236. The first button 142 or third button 146 may be depressed until the minute display 236 properly displays “26”. In a similar manner, the day (and a date if provided) may be entered into the alarm clock by utilizing the interface controls 280.

In this exemplary scenario, the user desires that at 7:26 PM, the camera 100 will to flash, play a recording and display a previously captured image of an object. Therefore, the interface controls 280 are activated until the camera shows that the strobe mode, audio mode and display mode are invoked (as portrayed by the strobe image 262, audio image 264 and display image 266 being illuminated on the display 150). In another exemplary embodiment, the selected time of day may be entered through a computer interface port (not shown). The manner in which the camera notifies the user of the arrival of the selected time of day will be described next.

With reference to FIG. 3, assuming that the camera 100 has been programmed for the 7:26 PM selected time of day, the camera 100 may sit idle until the selected time of day occurs. In one exemplary embodiment, the camera 100 may be in a “powered down” state whereby only the always-on portion 302 of the controller 202 is active. When the always-on portion 302 determines that the real time matches the programmed selected time of day, it may ‘wake’ the camera control processor 300. The camera control processor 300 may have been previously programmed as to the actions to be taken upon occurrence of the selected time of day. In the present exemplary scenario, the camera 100 is to flash, play an audio file and display an image. Therefore, the camera control processor 300 activates the strobe 206, thereby generating light in a ‘flash’. Additionally, the camera control processor 300 activates the speaker 212 and plays sound therefrom. Also, the camera control processor 300 reads image data from a memory device (e.g. storage media contained in the storage media device 210), processes such image data and display an image of the image data on the display 150. The noise from the speaker 212, image on the display 150 and the flash from the strobe 206 notifies the user of occurrence of the selected time of day. Notification may continue for a discrete duration of time or alternatively may continue until verification that a user has been notified. In the event that the notification continues until verification that a user has been notified, the alarm clock continues to play the sound, display the image and flash until the user takes action. Such action may be an event such as pressing the capture button 134, for example. Furthermore, a ‘sleep’ function may be provided whereby the user may delay the notification of occurrence of a selected time of day by a brief period of time (e.g. four minutes, seven minutes, 15 minutes, etc.). After such delay during the ‘sleep’ period, the notification may begin again until the user acknowledges the occurrence of the selected time of day.

In one embodiment, the camera 100 is provided with an alarm clock function whereby the alarm clock is able to invoke the capture of an image. In order to invoke the capture of an image, the camera 100 may be notified by the user of a selected time of day in a manner substantially similar to that previously described with respect to the audio mode, strobe mode and display mode. A difference being that in the present capture mode, the camera 100 illuminates the capture image 268 and captures image data representative of an imaged object upon occurrence of the selected time of day. Such capture of image data is invoked by the alarm clock.

In another embodiment, the camera 100 may be programmed to notify upon occurrence of a selected time of day through use of the microphone 214. In order to notify the camera 100 through the microphone 214, the camera control processor 300 may be provide with voice recognition software. As such, a user may simply verbalize commands rather than inputting commands through the interface controls (e.g. 280).

As previously stated, the camera alarm clock described herein may be used on any of a plurality of cameras including digital-type still cameras, digital-type motion cameras, film-type motion cameras, film-type still cameras and hybrids thereof.

The above described camera alarm clock feature increases the capabilities of the camera 100 and thus increases the value of the camera 100 to users. The alarm clock equipped camera eliminates the need for a user to carry a separate alarm clock and provides functions not available from stand-alone alarm clocks.

Types of cameras that may be provided with an alarm clock include any of a variety of cameras, such as digital-type still cameras, digital-type motion cameras, film-type motion cameras and film-type still cameras. All such cameras are within the scope of each of the appended claims unless precluded by express language of a subject claim. Although the exemplary embodiment specifically described herein is a digital-type still camera, it will be obvious to those skilled in the art after reading this disclosure that most other cameras, including all those described in patents incorporated by reference herein, could be modified to include an alarm clock.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1) A camera comprising:
a camera body; and
an alarm clock operably associated with said camera body.

2) The camera of claim 1 wherein said alarm clock further comprises at least one output device selected from a group of output devices consisting of:
a speaker, a strobe, a display and a capture device.

3) The camera of claim 1 wherein said alarm clock further comprises at least two output devices selected from a group of output devices consisting of:
a speaker, a strobe, a display and a capture device.

4) The camera of claim 1 wherein said alarm clock further comprises at least three output devices selected from a group of output devices consisting of:
a speaker, a strobe, a display and a capture device.

5) The camera of claim 1 wherein said alarm clock further comprises at least four output devices selected from a group of output devices consisting of:
a speaker, a strobe, a display and a capture device.

6) The camera of claim 2, said output device comprising said speaker.

7) The camera of claim 2, said output device comprising said strobe.

8) The camera of claim 2, said output device comprising said display.

9) The camera of claim 2, said output device comprising said capture device.

10) The camera of claim 1 and further comprising at least one element operatively associated with said alarm clock selected from a group of elements consisting of:
a memory storage device, a photosensor array, a computer connector, a real time clock, an always-on portion and a controller.

11) The camera of claim 2 and further comprising at least one element operatively associated with said alarm clock selected from a group of elements consisting of:
a memory storage device, a photosensor array, a computer connector, a real time clock, an always-on portion and a controller.

12) A method of providing notification of the occurrence of a time of day comprising:
inputting data representative of a selected time of day into a camera; and
upon occurrence of said selected time of day, actuating a camera subsystem.

13) The method of claim 12 wherein:
actuating a camera subsystem comprises activating at least one output device selected from a group of output devices consisting of:
a speaker, a strobe, a display and a capture device.

14) The method of claim 12 wherein:
actuating a camera subsystem comprises activating at least two output devices selected from a group of output devices consisting of:
a speaker, a strobe, a display and a capture device.

15) The method of claim 12 and further comprising:
storing data utilized by said camera subsystem for notifying a user of the occurrence of said selected time of day.

16) The method of claim 12 wherein said inputting comprises operating a camera control surface useable for controlling other camera functions.

17) A method of constructing a camera comprising:
mounting an image assembly in a camera housing; and
mounting an alarm clock in said camera housing.

18) A camera comprising:
means for capturing an image of an object;
means for selecting a time of day; and
means for actuating at least one camera subsystem at the occurrence of said selected time of day.
